(19) United States
(12) Patent Application Publication
(10) Pub. No.: US 2012/0179283 A1
(43) Pub. Date: Jul. 12, 2012

(54) MANAGING A PERFORMANCE OF SOLAR DEVICES THROUGHOUT AN END-TO-END MANUFACTURING PROCESS

(75) Inventor: Rainer Klaus Krause, Kostheim (DE)

(73) Assignee: INTERNATIONAL BUSINESS MACHINES CORPORATION, Armonk, NY (US)

(21) Appl. No.: 13/346,498

(22) Filed: Jan. 9, 2012

(30) Foreign Application Priority Data
Jan. 10, 2011 (EP) EP11150462

(51) Int. Cl. G05B 13/04

(52) U.S. Cl. 700/104

(57) ABSTRACT

The invention relates to managing performance of solar devices throughout a manufacturing process with multiple manufacturing steps. A method includes determining a plurality of key performance indicators for a solar device, determining a change behavior of each individual key performance indicator throughout manufacturing process steps, using a theoretical performance maximum of the solar device, comparing real performance of the solar device to the theoretical performance maximum, where the real performance is determined by key performance indicator changes throughout the entire manufacturing process resulting in a key performance indicator sensitivity matrix reflecting ultimate solar device performance, using the key performance indicator sensitivity matrix to improve each relevant manufacturing process step by modeling current manufacturing conditions to improve the key performance indicator, adapting the model in experimental manufacturing environment to match sensitivity curves between model and experiment, and using the model to calculate the performance of the solar devices.

### CROSS-REFERENCE TO RELATED APPLICATIONS

This patent application claims priority to European Patent Application No. EP11150462 filed on Jan. 10, 2011 for Rainer K. Krause, the entire contents of which are incorporated herein by reference for all purposes.

### FIELD

The present invention relates to a method and a system for managing a performance of solar devices throughout an end-to-end manufacturing process with multiple manufacturing process steps. The invention further relates to a computer-readable medium containing a set of instructions that causes a computer to perform the above method and a computer program product comprising a computer-readable medium for performing the above method.

### BACKGROUND

### Description of the Related Art

The initial quality of the raw material, i.e. the raw wafer, usually defines a maximum performance, which can be reached when the entire production process has terminated. Typically, the initial quality of the raw wafer is a limiting factor for the overall performance. With any manufacturing process step applied to the wafer, the performance usually decreases except for the case of very few exceptions, e.g. gettering or surface passivation, which are known in the art and not discussed with further detail. Accordingly, the raw material must be appropriately specified and controlled.

Management of manufacturing processes for solar devices, which are known in the art, merely relates to monitoring the manufacturing process and trying to improve individual steps of the manufacturing process depending on measurements performed on the solar device throughout the manufacturing process. Accordingly, the process steps can be modified when the measurements indicate deviations from the expected results. The manufacturing process itself is not tackled, especially not across the E2E outline. The modifications only refer to raw wafer, solar cell, solar module or solar installation processes.

Accordingly, a prediction of the performance of a solar device is not possible. Also, it is not possible to adapt a manufacturing process to produce solar devices having a certain performance. Furthermore, a process optimization can only be performed for the applied manufacturing steps. This makes it difficult to maximize the performance of the solar devices depending on the given raw material. Also the manufacturing process steps can only be optimized individually. Finally, the performance of the solar devices can only be evaluated after finishing the production process by testing. An adaptation of the manufacturing process to achieve a desired performance is rather complicated, especially under the consideration of different kinds of raw material having different characteristics.

### BRIEF SUMMARY

It is therefore an object of the invention to provide a method, a computer-readable medium, a computer program product and a system for managing a performance of solar devices throughout an end-to-end manufacturing process with multiple manufacturing process steps, which allows a detailed management of the manufacturing process and overcomes at least some of the above problems.

This object is achieved by the independent claims. Advantageous embodiments are detailed in the dependent claims.

Accordingly, this object is achieved by a method for managing a performance of solar devices throughout an end-to-end manufacturing process with multiple manufacturing process steps, the method comprising the steps of determining a plurality of key performance indicators for solar devices, determining a change behavior of each individual key performance indicator throughout manufacturing process steps, using the theoretical performance maximum of the solar device, comparing the real performance of said solar device to said theoretical performance maximum, wherein said real performance is determined by key performance indicator changes throughout the entire manufacturing process resulting in a key performance indicator sensitivity matrix reflecting the ultimate solar device performance, using said key performance indicator sensitivity matrix to improve each relevant manufacturing process step by modeling current manufacturing conditions to improve said key performance indicator, adapting said model in experimental manufacturing environment to match sensitivity curves between model and experiment, using said model to calculate the performance of the solar devices.

This object is also achieved by a computer-readable media such as a storage device, a floppy disk, compact disc, CD, digital versatile disc, DVD, Blu-ray disc, or a random access memory, RAM, containing a set of instructions that causes a computer to perform the above method and a computer program product comprising a computer-usable medium including a computer-usable program code, wherein the computer-usable program code is adapted to execute the above method.

The object is further achieved by a system for managing a performance of solar devices throughout an end-to-end manufacturing process with multiple manufacturing process steps comprising a storage device for storing computer usable program code and a processor for executing the computer usable program code to perform the above method.

Basic idea of the invention is to apply an end-to-end method for managing the production of a solar device from raw wafer to module level and even installation. This includes determining key performance indicators (KPI) for the manufacturing process, which determine the overall performance of the solar device. Any kind of KPI can be evaluated, including typical parameters known in the processing of silicon wafers. Determining key performance indicators can be done using Failure Mode and Effect Analysis (FMEA), Design of Experiment (DoE) modeling, data analysis and others. The behavior of the key performance indicators throughout the individual manufacturing process steps is determined to evaluate, which process steps have which effect on the key performance indicators. The change behavior of the KPIs is then evaluated using the theoretical performance maximum of the solar device. This is done by applying data analysis and modeling, data correlation and trend and significance analysis. According to the determined change behavior, a real performance of the solar device compared to the theoretical performance maximum is evaluated for each process step and added to a key performance indicator sensitivity matrix, which shows the impact of each processing step on the evaluated KPIs. Based on this KPI sensitivity matrix, the manufacturing process can be enhanced by modeling based on the KPIs. The model is verified in experimental manufacturing environment for further improvement. Accordingly, the manufacturing process steps are monitored from end-to-end with a statistically relevant number of samples to determine the impact of manufacturing process steps on the KPIs when being applied and to further adjust the manufacturing process. The model can be used to calculate the overall performance of the solar devices.

A modified embodiment of the present invention comprises the step of adjusting the manufacturing process and/or the choice of raw material to achieve a desired performance of the solar devices. In this case, manufacturing of solar devices with certain capabilities is desired and can be achieved in an economic way. By knowing details about the propagation of KPIs through the manufacturing process from end-to-end, preselecting and predefining the raw material and/or modifying the manufacturing process can be used to achieved a desired performance. The manufacturing process steps and the raw material can be optimized under consideration of costs, production time, manufacturing time, availability and others, so that the desired performance can be achieved in a most efficient way. By having detailed knowledge about the propagation of KPIs throughout the entire manufacturing process, a reliable prediction of the overall performance of the solar device is possible. Knowledge about the KPIs and their impact on the performance also enables to improve raw material specifications according to expected performance and cost performance data.

A modified embodiment of the invention comprises the step of using said model for solar device manufacturing to maximize the performance of the solar devices for a given raw material. With detailed knowledge about the change of the KPIs throughout the end-to-end manufacturing process, it is possible to achieve a maximum performance of the solar devices. The manufacturing process itself can be modeled to achieve a maximum performance and the outcome of the manufacturing process is monitored and fed back into the design of the manufacturing process for further improvement. For example additional manufacturing steps can be added, when it turns out that a change of KPIs occurs in an undesired way and processing steps can be added or enhanced to improve the KPIs. By a choice of the raw material, as described above, a theoretical maximum of the performance of the solar device can be defined and the manufacturing process steps can be adopted to provide a maximized performance for each of the different kinds of raw material. The maximum performance of a solar device can be achieved differently for different kinds of raw material. Knowledge about the KPIs and their impact on the performance also enables to improve raw material specifications for optimizing the performance.

A modified embodiment of the present invention further comprises the step of monitoring the key performance indicators throughout the manufacturing process of a solar device and detecting problems in manufacturing process by identifying deviations of the monitored key performance indicators from key performance indicators according to the model. By knowing details of the change of relevant KPIs throughout manufacturing processes, it is possible to detect problems in the manufacturing process, e.g. when at least one of the manufacturing process steps is faulty. When a model is statistically verified by a number of tests, already a small number of solar devices can indicate a significant fault in manufacturing process. Additionally, it is possible to identify the faulty process step by the impact on the KPIs.

In a modified embodiment of the present invention at least one of the key performance indicators being selected out of the group of front surface velocity, carrier lifetime, rear surface velocity, external front reflection, n-doping, p-doping or wafer thickness. These KPIs are used in the manufacturing of wafers and also in the area of photovoltaic solar devices. Hence, these KPIs form a relevant basis for selecting KPIs to be monitored in the inventive method.

In a modified embodiment of the present invention the step of comparing the real performance of said solar device to said theoretical performance maximum, wherein said real performance is determined by key performance indicator changes throughout the entire manufacturing process resulting in a key performance indicator sensitivity matrix reflecting the ultimate solar device performance comprises identifying manufacturing process steps having a most significant impact on the performance and modeling the entire manufacturing process based on these manufacturing process steps. Some manufacturing process steps have a higher impact on the overall performance of the solar device, i.e. on the KPIs, so that an improvement in these manufacturing process steps leads to the biggest improvement of the overall performance of the solar device. Focusing on these most critical steps can keep the manufacturing process simple and increase the efficiency in terms of time and costs.

In a modified embodiment of the present invention the step of determining a change behavior of each individual key performance indicator throughout manufacturing process steps comprises identifying key performance indicators having the biggest impact on the performance and selecting these key performance indicators for further application of the method. KPIs, which have a most significant impact on the performance of the solar device, can preferably be determined, since variations of these KPIs lead to most significant variations of the overall performance of the solar devices. Accordingly, the method can focus on such most significant KPIs, so that the manufacturing process can be kept reasonably simple, which increases the efficiency of the manufacturing process in terms of time and money.

In a modified embodiment of the present invention the step of determining a plurality of key performance indicators for solar devices comprises determining key performance indicators for raw wafers, solar cells, solar modules, and solar installations. KPIs for raw wafers, solar cells, and solar modules can be different and have to be evaluated depending on different phases of the manufacturing process. For example an overall performance of a solar module is determined by performance of its individual solar cells, whereby the selection of individual cells having similar characteristics is important for the overall performance. Such a KPI is not applicable for an individual solar cell.

A modified embodiment of the present invention further comprises the step of providing an ID to a manufactured solar device and tracking its performance throughout the manufacturing process. The ID allows tracking individual solar devices from one end to the other end of the manufacturing process, so that the impact of individual manufacturing process steps to the KPIs and the overall performance of the solar device can reliably be evaluated.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

A system for managing a performance of solar devices throughout an end-to-end manufacturing process with multiple manufacturing process steps, in one embodiment, includes a storage device for storing computer usable program code and a processor for executing the computer usable program code. The computer usable program code includes determining a plurality of key performance indicators for a solar device, determining a change behavior of each individual key performance indicator throughout manufacturing process steps of a manufacturing process, and using a theoretical performance maximum of the solar device.

The computer usable program code includes, in the embodiment, comparing real performance of the solar device to the theoretical performance maximum, where the real performance is determined by key performance indicator changes throughout the entire manufacturing process resulting in a key performance indicator sensitivity matrix reflecting the ultimate solar device performance. The computer usable program code, in the embodiment, includes adapting the model in an experimental manufacturing environment to match sensitivity curves between model and experiment, and using the model to calculate performance of the solar devices.

### BRIEF DESCRIPTION OF THE DRAWINGS

Preferred embodiments of the invention are illustrated in the accompanied figures. These embodiments are merely exemplary, i.e. they are not intended to limit the content and scope of the appended claims.

FIG. 1 shows a flow graph of the inventive method of managing a manufacturing process for solar devices;

FIG. 2 shows a table containing a set of KPIs versus different manufacturing steps showing the impact on each KPI of each manufacturing step qualitatively;

FIG. 3 contains a table showing a quantitative change of a set of key performance indicators throughout a set of different manufacturing process steps;

FIG. 4 shows a diagram indicating changes to the key performance indicators and resulting overall performance of the solar device throughout different manufacturing process steps according to FIG. 3;

FIG. 5 shows a diagram indicating improvements of the solar device regarding efficiency and output of the manufacturing process throughout different manufacturing process steps according to FIG. 3;

FIG. 6 contains a table showing a quantitative change of a set of key performance indicators throughout a second set of different manufacturing process steps;

FIG. 7 shows a diagram indicating changes to the key performance indicators and resulting overall performance of the solar device throughout different manufacturing process steps according to FIG. 6;

FIG. 8 shows a diagram indicating improvements of the solar device regarding efficiency and output of the manufacturing process throughout different manufacturing process steps according to FIG. 6;

FIG. 9 shows a process flow describing a KPI improvement approach; and

FIG. 10 shows a process of continuous adaptation of a manufacturing process step.

### DETAILED DESCRIPTION

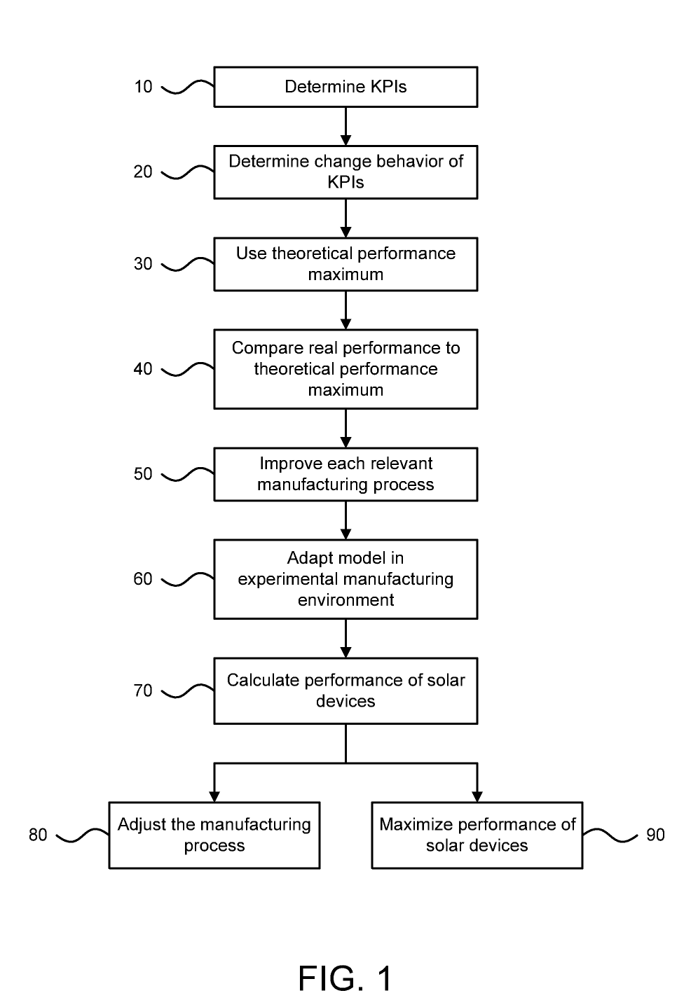

Referring now to FIG. 1, a flowchart of a method for managing a performance of solar devices throughout an end-to-end-manufacturing process consisting of multiple manufacturing process steps is shown.

The method starts in step 10 with determining a plurality of key performance indicators (KPIs) for solar devices. The KPIs can be any suitable indicators applicable to a manufacturing process of solar devices, e.g. based on prior knowledge on similar manufacturing processes. Typical KPIs are front surface velocity (FSV), carrier life time (CLT), rear surface velocity (RSV), external front reflection (EFR) n-doping, p-doping or wafer thickness.

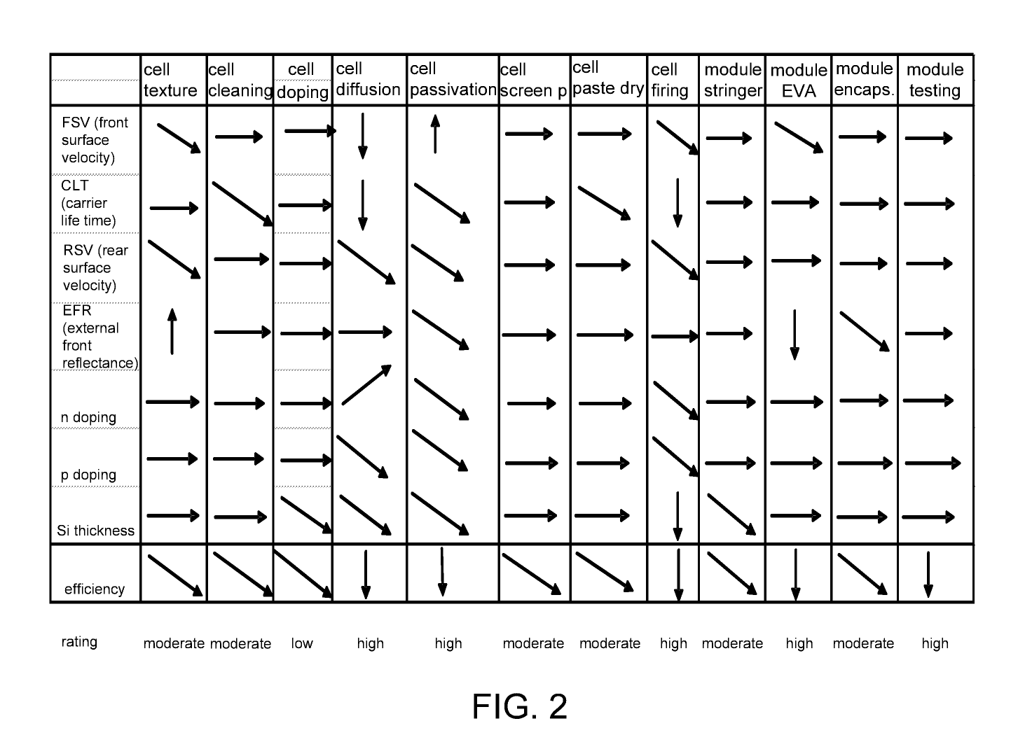

In step 20, a change behavior of KPIs is determined throughout manufacturing process steps for manufacturing solar devices. According to FIG. 2, a set of KPIs comprising the afore-mentioned is listed in a table versus different manufacturing process steps. For each manufacturing process step, the impact on this step on the respective KPI is indicated by an arrow. The arrow provided in a horizontal direction indicates that the KPI is essentially not changed, the arrow arranged vertically upward or downward direction indicates a major impact of the manufacturing process step on the respective KPI, and an inclined error indicates a moderate impact of the manufacturing process step on the respective KPI.

A theoretical performance maximum of the solar device is evaluated in step 30. The theoretical performance maximum is evaluated based on the impact of applied manufacturing process steps and the raw material used. In this case, raw material refers to a wafer used for manufacturing a solar cell, which has a limiting character for the overall performance of the solar device.

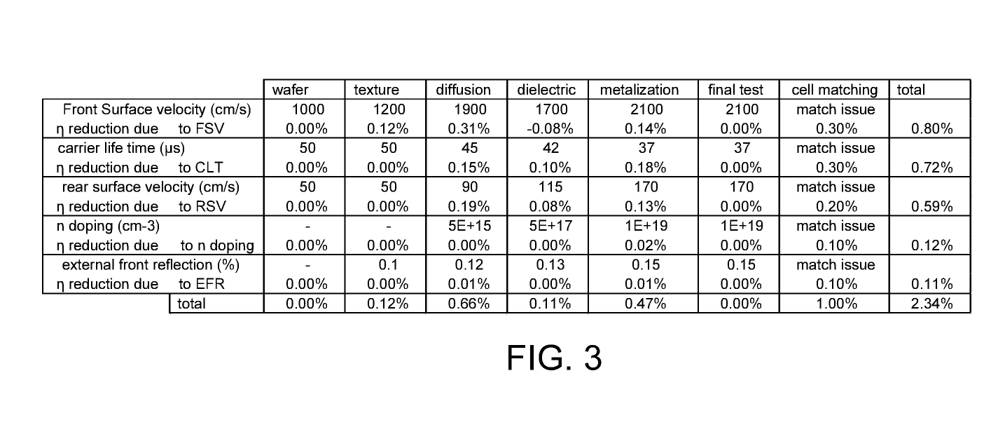

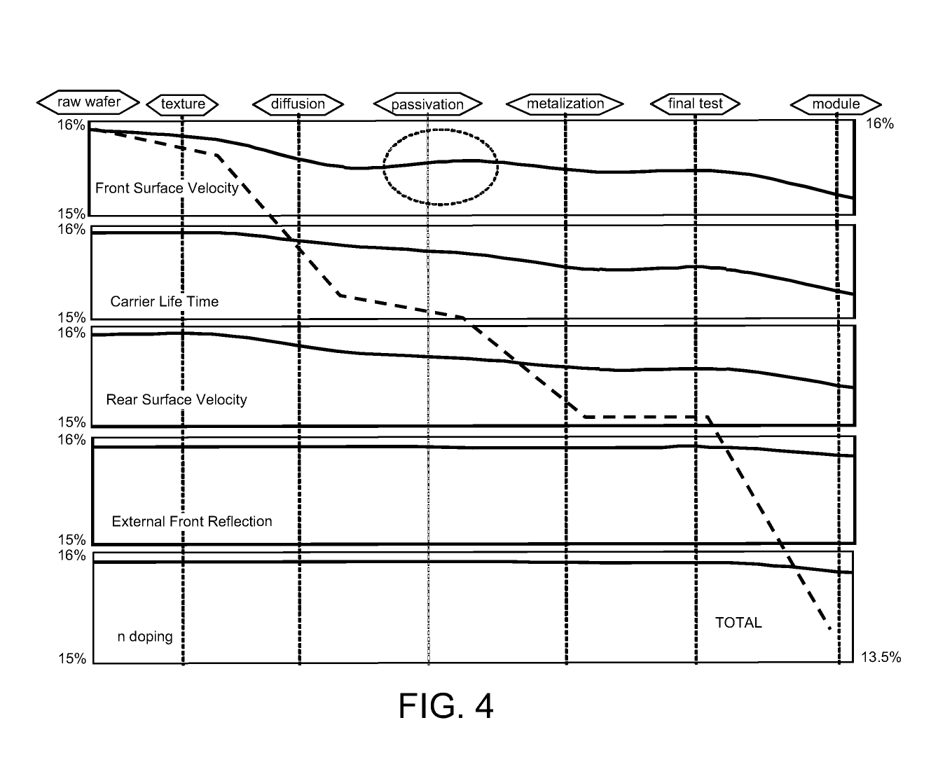

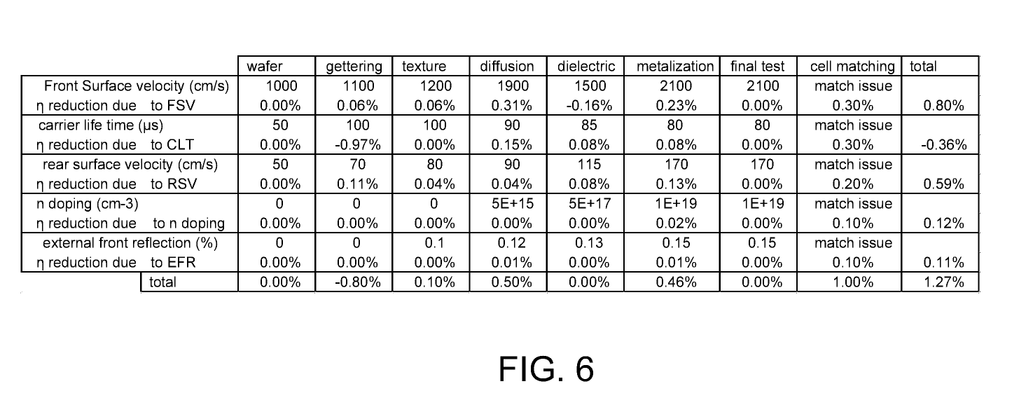

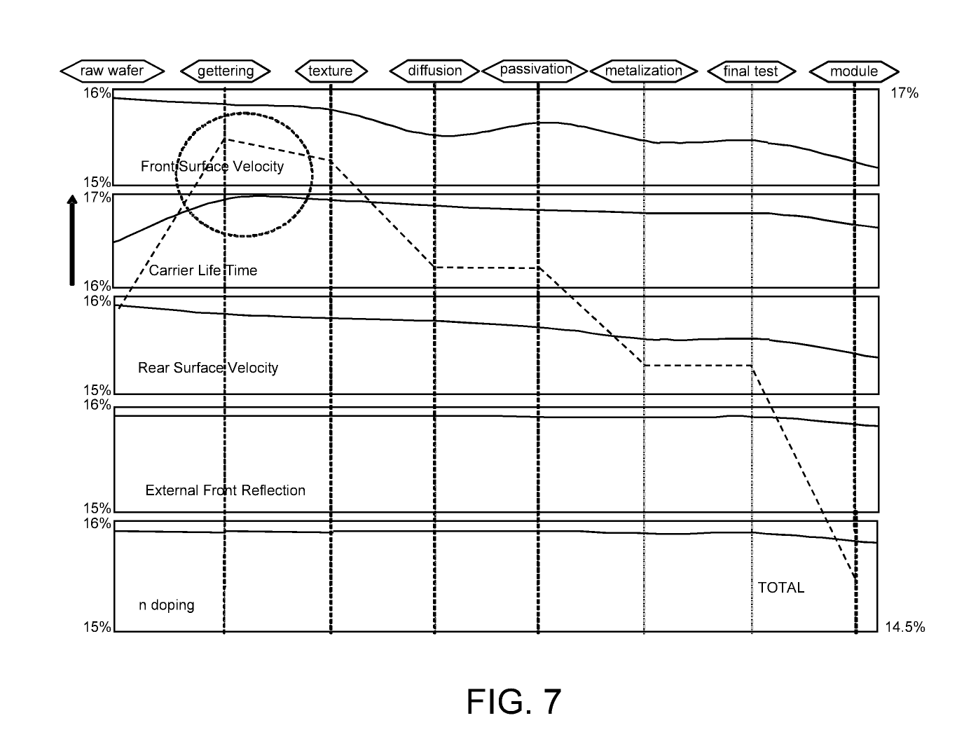

According to step 40, the real performance of said solar device is compared to said solar device is compared to said theoretical performance maximum. The real performance is determined by the evaluation of changes of the KPIs throughout the entire manufacturing process based on measurements. The measurements have to be performed on a statistically significant number of devices so that reliable information regarding the real implementation of a manufacturing process can be achieved. The propagation of the KPIs is entered into a key performance indicator sensitivity matrix reflecting the overall solar device performance. This matrix corresponds to the table of FIG. 3 for process steps of a first exemplary manufacturing process and the table of FIG. 6 for process steps of a second exemplary manufacturing process. As can be seen in the two tables, impact of each of the KPIs and of the different manufacturing process steps to the overall performance of the solar device can easily be evaluated. According to FIG. 3, it can be seen that the KPIs FSV, CLT and RSV have the most significant impact on the overall performance of the solar device. In respect to manufacturing process steps, the steps of cell diffusion, metallization and cell matching have the most significant impact on the performance of the solar device. As indicated in FIG. 4, which shows a graphical representation of KPIs and the overall performance of the solar device throughout the first exemplary manufacturing process, passivation has a positive impact on the FSV, as indicated by the circle in the figure. According to FIG. 6, KPIs FSV, CLT and RSV are also most important, whereby in this example the KPI carrier life time can even be improved compared to the initial value based on the provided manufacturing process, as indicated by the negative impact on the total performance. Similarly, the manufacturing process steps of gettering, cell diffusion and cell matching have the biggest impact on the overall performance of the solar device, whereby gettering is the only manufacturing step that improves the overall performance, as indicated by the negative impact of this manufacturing process step. As indicated in FIG. 7, which shows a graphical representation of KPIs and the overall performance of the solar device throughout the second exemplary manufacturing process, gettering has a positive impact on the CLT and even increases the overall performance of the solar device, as indicated by the circle in the figure.

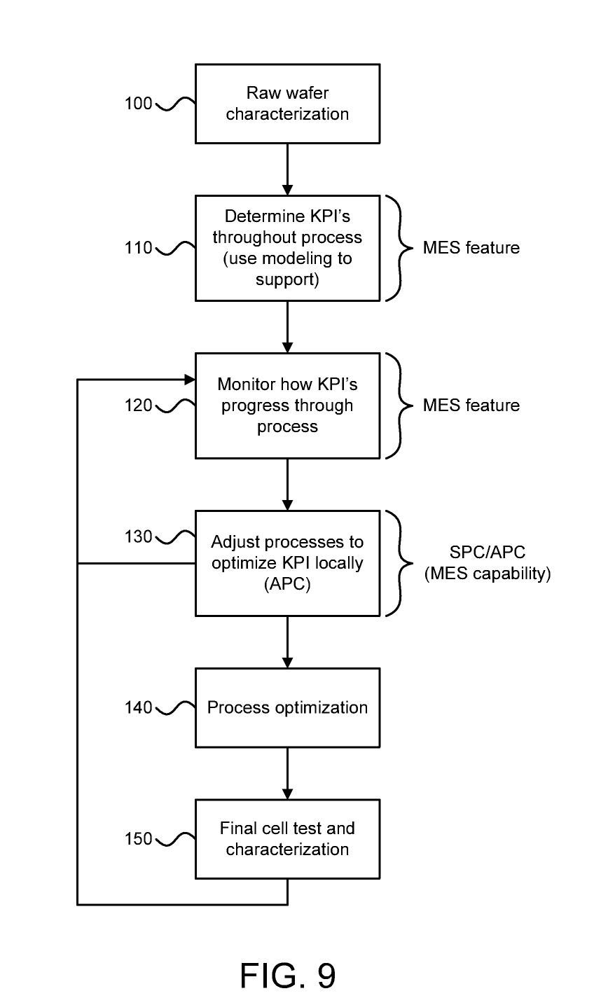

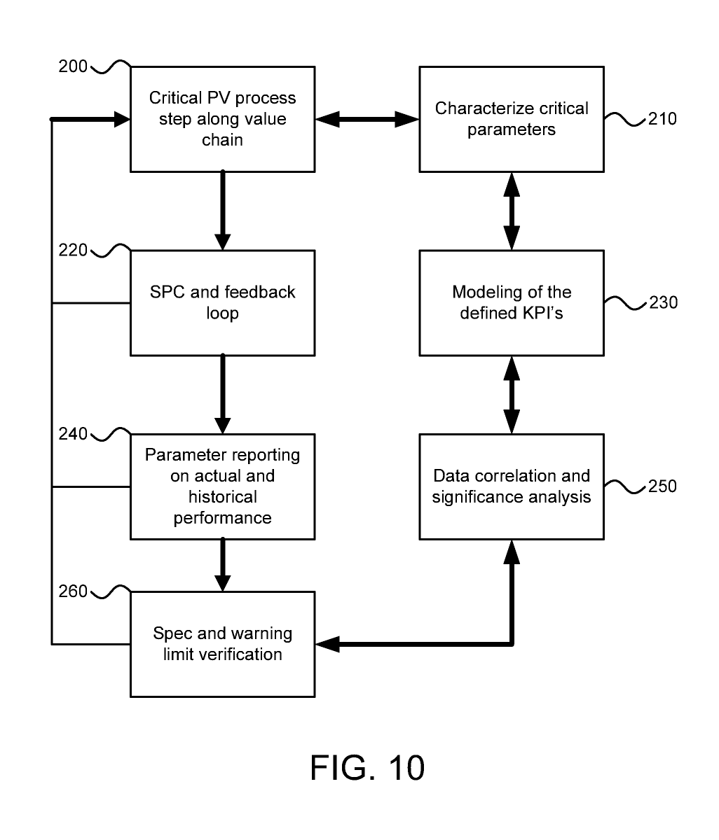

According to step 50, said key performance indicator is improved for each manufacturing step. Details are described later in respect to FIGS. 9 and 10.

In step 60, the above model is adapted in an experimental manufacturing environment to match sensitivity curves between model and experiment.

In step 70, the model is used to calculate the performance of the solar devices. The model at this stage comprises a theoretical modeling, which is backed up with the measurement of the KPIs provided throughout the manufacturing process and therefore provides a reliable basis for calculating the performance of the solar devices. The calculation can be performed, as seen in FIGS. 3 and 6, by determining the impact of each KPI and each manufacturing process individually, summing up the overall impact on the performance of the solar devices.

In this embodiment of the present invention the method further comprises optional steps 80 and 90.

According to step 80, the manufacturing process and/or the choice of raw material is adjusted to achieve a desired performance of the solar devices. For economic reasons, the maximum performance, which can technically be achieved, is not always desired. The precise knowledge about the behavior of the KPIs throughout the entire manufacturing process allows for a precise adaptation of the manufacturing process to achieve the desired performance.

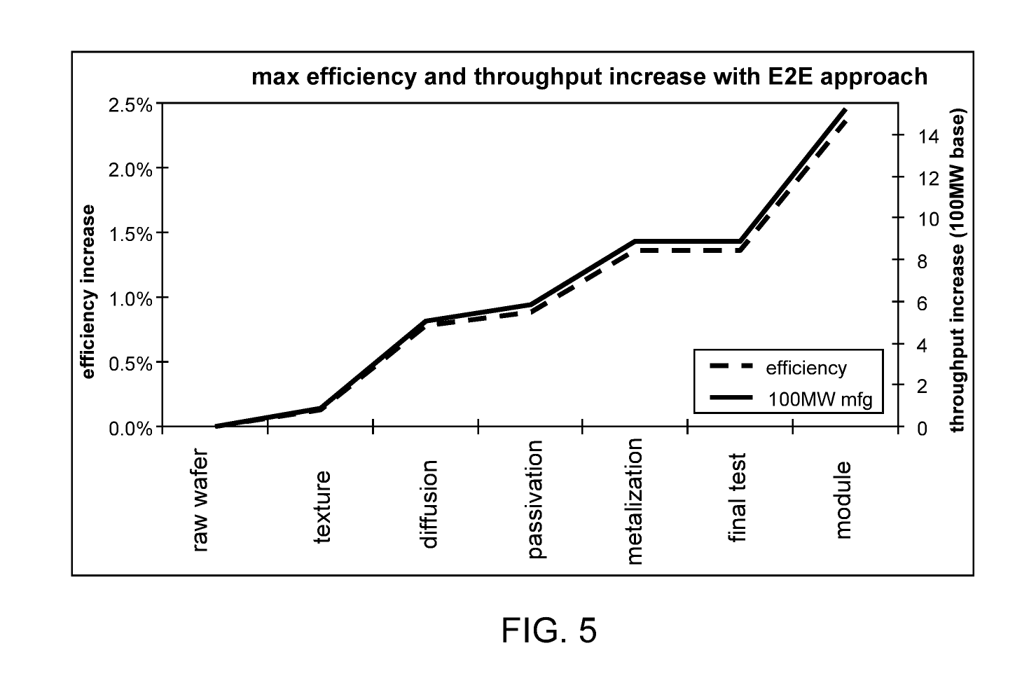

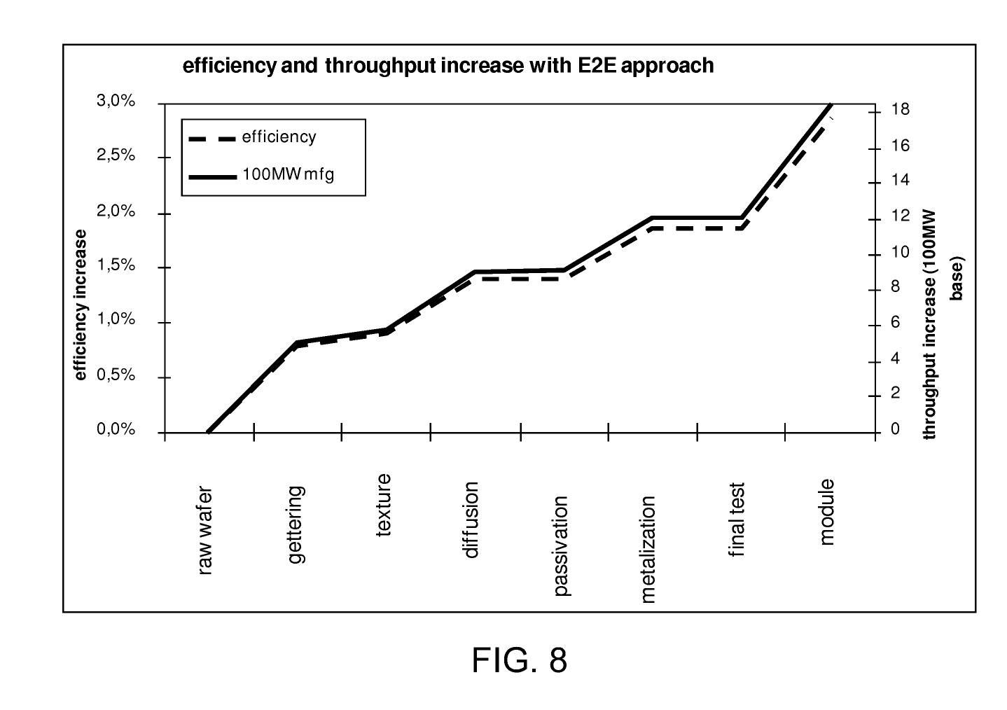

According to alternative step 90, the model is used to maximize the performance of the solar devices for a given raw material. Based on the detailed knowledge about the characteristics of the raw material as defined by the KPIs and the changes of the KPIs throughout the entire manufacturing process the most suitable raw material can be selected and the manufacturing process steps can be each optimized to provide the solar devices with the maximum performance. Improvements of the manufacturing process due to the use of the inventive model are shown in FIGS. 5 and 8 in respect to the first and second exemplary manufacturing process, respectively.

Referring now to FIG. 9, a process flow describing the improvement of a KPI is shown.

According to step 100, the KPIs is of the raw wafer are characterized

According to step 110, the KPIs are determined throughout the entire manufacturing process. This requires modeling to support the calculation of the KPIs. This step is based on a manufacturing execution system (MES), which is known in the art.

In step 120, it is monitored how KPIs propagate through the manufacturing process. Also this is a MES feature. This step refers to gathering KPI measurements from real manufacturing processes as they have been defined by modeling.

In step 130, the manufacturing process steps are adjusted to optimize KPIs locally. Divergences between the model and the real devices are evaluated and the model is adapted. This is also a MES capability and uses statistical process control (SPC) and an automatic process control (APC).

In step 140, a process optimization is performed. The process optimization refers to the overall behavior of the KPIs through the manufacturing process compared to the local improvement of KPIs, as performed for individual manufacturing process steps in step 130.

According to step 150, a final cell test and characterization of the solar device is performed. The data is passed back to step 120, so that the method performs continuous improvement of the manufacturing step.

According to FIG. 10, another process flow for the improvement within of KPIs in an individual manufacturing process step along a manufacturing process is shown.

In step 200, a critical manufacturing process step for the manufacturing of the photovoltaic solar device is identified and selected. The identification can be based on the tables as shown in FIGS. 3 and 6, which allow a simple identification of manufacturing process steps having a most significant impact on the overall performance of the solar device. As indicated in field 210, critical parameters are identified as KPIs and characterized within the critical manufacturing process step.

In step 220, which is subsequent to step 200, an SPC end feedback loop is applied to evaluate a change of the identified KPIs. The feedback can be directly provided to step 200. The information is also used as indicated by field 230 for modeling the defined KPIs, further based on the characterization of critical parameters according to field 210.

According to step 240, which is subsequent to step 220, a parameter reporting on actual and historical performance of the KPIs is performed. This refers to a data a data correlation and significance analysis as indicated by field 250, which uses the model according to field 230 as basis.

In step 260, a specification and warning limit verification is applied. This makes use of the data correlation and significance analysis according to field 250. The data is then fed back to step 200, where the data is used to describe and define the KPIs of the manufacturing process step.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the invention has been illustrated and described in detail in the drawings and fore-going description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

What is claimed is:

1. A method for managing a performance of solar devices throughout an end-to-end manufacturing process with multiple manufacturing process steps, the method comprising the steps of:
determining a plurality of key performance indicators for a solar device;
determining a change behavior of each individual key performance indicator throughout manufacturing process steps of a manufacturing process;
using a theoretical performance maximum of the solar device;
comparing real performance of the solar device to the theoretical performance maximum, wherein the real performance is determined by key performance indicator changes throughout the entire manufacturing process resulting in a key performance indicator sensitivity matrix reflecting the ultimate solar device performance;
using the key performance indicator sensitivity matrix to improve each relevant manufacturing process step by modeling current manufacturing conditions to improve one or more of the key performance indicators;
adapting the model in an experimental manufacturing environment to match sensitivity curves between model and experiment; and
using the model to calculate performance of the solar devices.

2. The method of claim 1, further comprising one or more of adjusting the manufacturing process and a choice of raw material to achieve a desired performance of the solar devices.

3. The method of claim 1, further comprising using the model for solar device manufacturing to maximize performance of the solar devices for a given raw material.

4. The method of claim 1, further comprising monitoring the key performance indicators throughout a manufacturing process of a solar device and detecting problems in the manufacturing process by identifying deviations of the monitored key performance indicators from key performance indicators according to the model.

5. The method of claim 1, wherein at least one of the key performance indicators comprises one of front surface velocity, carrier lifetime, rear surface velocity, external front reflection, n-doping, p-doping and wafer thickness.

6. The method of claim 1, whereby the step of comparing the real performance of the solar device to the theoretical performance maximum, wherein the real performance is determined by key performance indicator changes throughout the entire manufacturing process resulting in a key performance indicator sensitivity matrix reflecting the ultimate solar device performance comprises identifying manufacturing process steps having a most significant impact on performance and modeling of the entire manufacturing process based on the manufacturing process steps of the manufacturing process.

7. The method of claim 1, whereby the step of determining a change behavior of each individual key performance indicator throughout manufacturing process steps comprises identifying key performance indicators having a biggest impact on the performance and selecting the key performance indicators having a biggest impact for further application of the method.

8. The method of claim 1, whereby the step of determining a plurality of key performance indicators for solar devices comprises determining key performance indicators for one or more of raw wafers, solar cells, solar modules, and solar installations.

9. The method of claim 8, further comprising binning one or more of raw wafer, solar cells, and solar modules according to key performance indicators of the raw wafer, the solar cells, and the solar modules.

10. The method of claim 1, further comprising providing an ID to a manufactured solar device and tracking performance of the solar device throughout a manufacturing process of the manufactured solar device.

11. A computer program product for managing a performance of solar devices throughout an end-to-end manufacturing process with multiple manufacturing process steps, the computer program product comprising a computer readable storage medium having computer readable program code embodied therein, the computer readable program code configured to:
determining a plurality of key performance indicators for a solar device;
determining a change behavior of each individual key performance indicator throughout manufacturing process steps of a manufacturing process;
using a theoretical performance maximum of the solar device;
comparing real performance of the solar device to the theoretical performance maximum, wherein the real performance is determined by key performance indicator changes throughout the entire manufacturing process resulting in a key performance indicator sensitivity matrix reflecting the ultimate solar device performance;
using the key performance indicator sensitivity matrix to improve each relevant manufacturing process step by modeling current manufacturing conditions to improve one or more of the key performance indicators;
adapting the model in an experimental manufacturing environment to match sensitivity curves between model and experiment; and
using the model to calculate performance of the solar devices.

12. The computer program product of claim 11, further comprising one or more of adjusting the manufacturing process and a choice of raw material to achieve a desired performance of the solar devices.

13. The computer program product of claim 11, further comprising using the model for solar device manufacturing to maximize performance of the solar devices for a given raw material.

14. The computer program product of claim 11, further comprising monitoring the key performance indicators throughout a manufacturing process of a solar device and detecting problems in the manufacturing process by identifying deviations of the monitored key performance indicators from key performance indicators according to the model.

15. The computer program product of claim 11, wherein at least one of the key performance indicators comprises one of front surface velocity, carrier lifetime, rear surface velocity, external front reflection, n-doping, p-doping and wafer thickness.

16. The computer program product of claim 11, whereby the step of comparing the real performance of the solar device to the theoretical performance maximum, wherein the real performance is determined by key performance indicator changes throughout the entire manufacturing process resulting in a key performance indicator sensitivity matrix reflecting the ultimate solar device performance comprises identifying manufacturing process steps having a most significant impact on performance and modeling of the entire manufacturing process based on the manufacturing process steps of the manufacturing process.

17. The computer program product of claim 11, whereby the step of determining a change behavior of each individual key performance indicator throughout manufacturing process steps comprises identifying key performance indicators having a biggest impact on the performance and selecting the key performance indicators having a biggest impact for further application of the method.

18. A system for managing a performance of solar devices throughout an end-to-end manufacturing process with multiple manufacturing process steps, the system comprising:
a storage device for storing computer usable program code; and
a processor for executing the computer usable program code, the computer usable program code comprising
determining a plurality of key performance indicators for a solar device;
determining a change behavior of each individual key performance indicator throughout manufacturing process steps of a manufacturing process;
using a theoretical performance maximum of the solar device;
comparing real performance of the solar device to the theoretical performance maximum, wherein the real performance is determined by key performance indicator changes throughout the entire manufacturing process resulting in a key performance indicator sensitivity matrix reflecting the ultimate solar device performance;
using the key performance indicator sensitivity matrix to improve each relevant manufacturing process step by modeling current manufacturing conditions to improve one or more of the key performance indicators;
adapting the model in an experimental manufacturing environment to match sensitivity curves between model and experiment; and
using the model to calculate performance of the solar devices.

19. The system of claim 18, further comprising a computer comprising the storage device and the processor.

20. The system of claim 18, further comprising manufacturing equipment controlled by the computer, the manufacturing process implementing the manufacturing steps of the manufacturing process.
